(19) United States
(12) Patent Application Publication
(10) Pub. No.: US 2026/0181524 A1
(43) Pub. Date: Jun. 25, 2026

(54) COMMUNICATION CONTROL APPARATUS AND COMMUNICATION CONTROL METHOD

(71) Applicant: KUNIAKI MATSUI, Sakai City (JP)

(72) Inventor: KUNIAKI MATSUI, Sakai City (JP)

(21) Appl. No.: 19/419,332

(22) Filed: Dec. 15, 2025

(30) Foreign Application Priority Data
Dec. 24, 2024 (JP) 2024-227714

(51) Int. Cl. H04W 40/24

(52) U.S. Cl. CPC H04W 40/24

(57) ABSTRACT

In a communication control apparatus that functions while being incorporated into a main body device, at a connection start timing when a connector of an external device is connected to a connector connection port, in a state where both a role of the main body device and a role of the external device are set to a host mode, at least part of a data communication circuit is caused to be in a disconnected state, the main body device is caused to perform an initial operation under a sink mode under which the main body device receives power supply from the external device, the role of the external device is switched to be in a device mode, and then the data communication circuit in the disconnected state is switched to be in the connection state.

### INCORPORATION BY REFERENCE

This application is based upon and claims the benefit of priority from the corresponding Japanese Patent Application No. 2024-227714 filed on Dec. 24, 2024, the entire contents of which are incorporated herein by reference.

### BACKGROUND

The disclosure relates to a communication control apparatus and a communication control method, and more particularly, to a communication control apparatus that functions while being incorporated into a main body device and a communication control method therefor.

In recent years, in electronic devices such as electronic paper and tablets, a USB Power Delivery (PD) technique has been used in which power is supplied from an external device via a USB cable such as a USB Type C cable.

When two devices are connected to each other via a USB cable, it is necessary to set one of them to a mode (host mode) of functioning as a host and set the other to a mode (device mode) of functioning as a device. In this case, the device set to the host mode (hereinafter, referred to as a host-side device) can control the device set to the device mode (hereinafter, referred to as a device-side device).

On the other hand, at the time of initial connection, power needs to be supplied from the host-side device to the device-side device with no exception. That is, the host-side device is set to a source mode of supplying power, and the device-side device is set to a sink mode of receiving the power.

As a technique related to such power supply by USB PD, there has been known an electronic device that determines whether a USB PD port serves as the source or the sink, based on negotiation executed with another electronic device at a timing when the other electronic device is connected to the USB PD port, then determines whether the other electronic device supports a source/sink switching function, and switches the source/sink by a user operation upon determining that the other electronic device supports the switching function.

### SUMMARY

The disclosure has been made in view of the above circumstances, and an object thereof is to provide a communication control apparatus and a communication control method that enable power supply from an external device to a main body device while avoiding collision of data signals when a connector of the external device is connected.

The disclosure provides a communication control apparatus that functions while being incorporated into a main body device, the communication control apparatus including: a connector connection port to which a connector of an external device is connectable; a data communication circuit that performs data communication between the external device and the main body device; a role control communication circuit that performs communication for controlling a role of the external device between the external device and the main body device; an external device role switcher that switches the role of the external device between a host mode under which the external device operates as a host and a device mode under which the external device operates as a device; a communication circuit switcher that switches a connection state of the data communication circuit between an energized state and a disconnected state; and a controller that controls the external device role switcher and the communication circuit switcher, wherein at a connection start timing when the connector of the external device is connected to the connector connection port, in a state where both a role of the main body device and the role of the external device are set to the host mode, the controller causes the communication circuit switcher to set at least part of the data communication circuit to be in the disconnected state, causes the main body device to perform an initial operation under a sink mode under which the main body device receives power supply from the external device, causes the external device role switcher to switch the role of the external device to the device mode, and then causes the communication circuit switcher to switch the data communication circuit in the disconnected state to the connection state.

The disclosure further provides a communication control method for a communication control apparatus that functions while being incorporated into a main body device, the communication control method including: connecting a connector of an external device to a connector connection port of the main body device; causing, at a connection start timing when the connector of the external device is connected to the connector connection port, in a state where both a role of the main body device and a role of the external device are set to a host mode under which the external device operates as a host, at least part of a data communication circuit that performs data communication between the external device and the main body device to be in a disconnected state, and the main body device to perform an initial operation under a sink mode under which the main body device receives power supply from the external device; switching the role of the external device to a device mode under which the external device operates as a device; and switching the data communication circuit in the disconnected state to a connection state.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a block diagram illustrating a schematic configuration of an electronic paper system of the disclosure.

FIG. 2 is a block diagram illustrating a schematic configuration of electronic paper illustrated in FIG. 1.

FIGS. 3A and 3B are explanatory diagrams illustrating problems with known USB connection.

FIG. 4 is a flowchart illustrating an example of USB connection processing of the electronic paper system of FIG. 1.

FIGS. 5A and 5B are explanatory diagrams illustrating an outline of the USB connection processing of the electronic paper system in FIG. 1.

### DETAILED DESCRIPTION

Further, preferred aspects of the disclosure will be described.

In the communication control apparatus of the disclosure, the communication circuit switcher may be a semiconductor switching element.

With this configuration, by switching the communication circuit by the semiconductor switching element, it is possible to realize a communication control apparatus that enables power supply from the external device to the main body device while avoiding collision of data signals when the connector of the external device is connected.

In the communication control apparatus of the disclosure, the controller may cause the communication circuit switcher to maintain the data communication circuit in the disconnected state when the controller cannot cause the external device role switcher to switch the role of the external device to the device mode.

With this configuration, when the role of the external device cannot be switched to the device mode, the data communication circuit is maintained in the disconnected state, thereby making it possible to realize a communication control apparatus that enables power supply from the external device to the main body device while avoiding collision of data signals when the connector of the external device is connected.

In the communication control apparatus of the disclosure, the role of the main body device may constantly function under the host mode, and the main body device may constantly function under the sink mode.

With this configuration, even when the role of the main body device constantly functions under the host mode and the main body device constantly functions under the sink mode, it is possible to realize a communication control apparatus that enables power supply from the external device to the main body device while avoiding collision of data signals when the connector of the external device is connected.

In the communication control apparatus of the disclosure, the connector may be a USB Type C interface.

With this configuration, also with the connector of the USB Type C interface, it is possible to realize a communication control apparatus that enables power supply from the external device to the main body device while avoiding collision of data signals when the connector of the external device is connected.

In the communication control apparatus of the disclosure, the role control communication circuit may be a CC1 line and a CC2 line of the USB Type C interface.

With this configuration, by using the CC1 line and the CC2 line of the USB Type C interface for role control communication, it is possible to realize a communication control apparatus that enables power supply from the external device to the main body device while avoiding collision of data signals when the connector of the external device is connected.

In the communication control apparatus of the disclosure, the data communication circuit may be a TX1+ line, a TX1− line, an RX1+ line, an RX1− line, a D+ line, and a D− line of the USB Type C interface.

With this configuration, by using the TX1+ line, the TX1− line, the RX1+ line, the RX1− line, the D+ line, and the D− line of the USB Type C interface for data communication, it is possible to realize a communication control apparatus that enables power supply from the external device to the main body device while avoiding collision of data signals when the connector of the external device is connected.

Hereinafter, the disclosure will be described in further detail using the drawings. Note that the following description is in all aspects illustrative and it should not be understood as limiting the disclosure.

### First Embodiment

### Configuration of Electronic Paper System 100

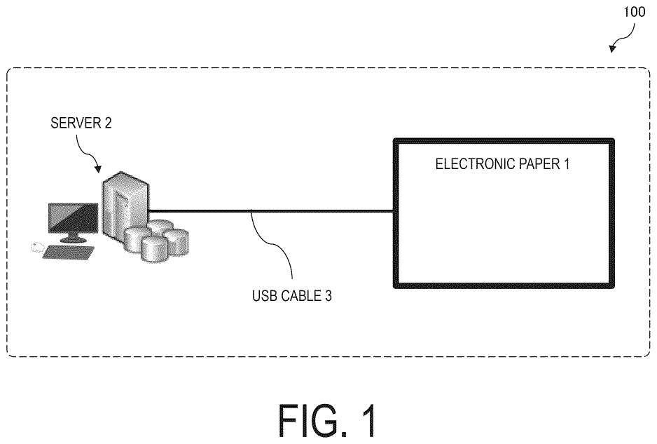

Next, an electronic paper system 100 including electronic paper 1 as an example of a main body device incorporating a communicator 13 as an example of a communication control apparatus according to a first embodiment of the disclosure will be described based on FIG. 1.

FIG. 1 is a block diagram illustrating a schematic configuration of the electronic paper system 100 of the disclosure.

As illustrated in FIG. 1, the electronic paper system 100 includes the electronic paper 1 and a server 2 connected to each other via a USB cable 3.

In the first embodiment, the “main body device” of the disclosure is realized by the electronic paper 1.

In addition, the “external device” of the disclosure is realized by the server 2.

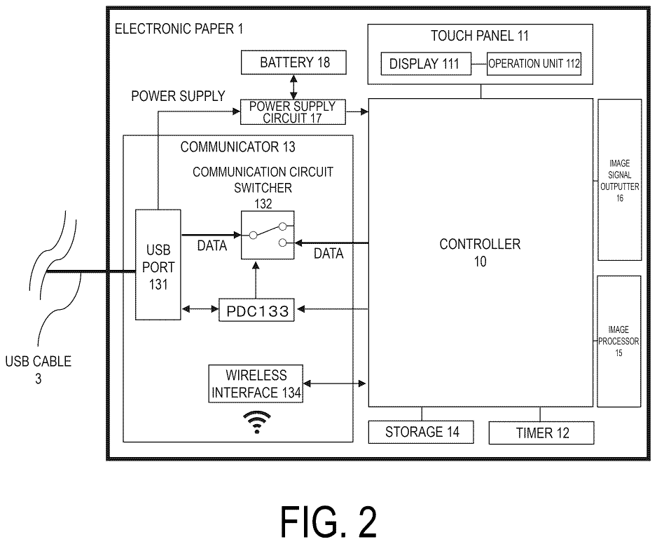

FIG. 2 is a block diagram illustrating a schematic configuration of the electronic paper 1 illustrated in FIG. 1.

As illustrated in FIG. 2, the electronic paper 1 includes a controller 10, a touch panel 11, a timer 12, a communicator 13, a storage 14, an image processor 15, an image signal outputter 16, a power supply circuit 17, and a battery 18.

Hereinafter, each component of the electronic paper 1 will be described.

The controller 10 collectively controls the electronic paper 1 and includes at least one central processing unit (CPU), at least one system on a chip (SoC), at least one random access memory (RAM), at least one read only memory (ROM), at least one control circuit, various interface circuits, and the like.

The controller 10 performs monitoring and control of detection of each sensor and all loads such as the touch panel 11 and the communicator 13, in order to control operations of the entire electronic paper 1.

The touch panel 11 is a unit including a liquid crystal display, and includes a display 111 and an operation unit 112.

The electronic paper 1 does not necessarily need to have a touch panel function, and may have only the operation unit 112 that is mechanically driven.

The display 111 displays various types of information.

The display 111 includes color particles (not illustrated) that move in response to application of a predetermined write voltage from the battery 18. The color particles are, for example, charged organic or inorganic particles, and a predetermined display image is displayed on the display 111 through electrophoresis in which the color particles move or rotate in a dispersion liquid (not illustrated) according to the write voltage applied between two electrodes (not illustrated).

The display method of the display 111 is not limited to the electrophoretic method, and may be, for example, a particle rotation method of rotating charged particles, a magnetophoretic method of moving particles by magnetism, or a method using liquid crystals or an EL element.

The operation unit 112 is a part that is configured by a touch panel, displays a display image based on image data acquired from the server 2, and receives a command from a user through the touch panel.

The timer 12 is a part that measures and counts time and acquires, for example, a clock time through an incorporated clock or a network (not illustrated).

The timer 12 is used, for example, to measure the time for acquiring image data from the server 2.

The communicator 13 is a part that performs communication with the external server 2 via the USB cable 3, and receives image data.

The communicator 13 includes a USB port 131, a communication circuit switcher 132, a power delivery controller (PDC) 133, and a wireless interface 134.

The USB port 131 is a connector connection port to which a connector of the USB cable 3 is connectable.

In the case of USB Type C cables, the USB port 131 corresponds to a USB Type C port.

The controller 10 controls the server 2 by sending a control signal to the server 2 via the USB port 131.

The USB port 131 supplies power to the power supply circuit 17 via the USB cable 3.

The communication circuit switcher 132 is a switch that electrically switches between ON and OFF of a connection state of a data communication circuit for data communication performed with the server 2.

In the case of USB Type C cables, the data communication circuit corresponds to six data-transfer lines that are a TX1+ line, a TX1− line, an RX1+ line, an RX1− line, a D+ line, and a D− line of the USB Type C.

In the case of products conforming to the USB 2.0 standard, only two data-transfer lines that are the D+ line and the D-line are used for the data communication, and four data-transfer lines that are the TX1+ line, the TX1− line, the RX1+ line, and the RX1− line are not used for the data communication.

Therefore, in the case of products conforming to the USB 2.0 standard, the external device role switcher may switch the connection states only for two of the six data-transfer lines that are the D+ line and the D-line used for the data communication.

In the case of products conforming to the USB 3.x dual-lane standard, all of the six data-transfer lines are used for data transfer, and thus the external device role switcher needs to switch the connection states for all the six data-transfer lines.

The PDC 133 performs communication for controlling the role of the server 2, between the server 2 and the electronic paper 1.

The PDC 133 performs control to switch between ON and OFF of the communication circuit switcher 132 according to the switching state of the role of the server 2.

In the case of USB Type C cables, the PDC 133 switches the role of the server 2 using the CC1 line and the CC2 line of the USB Type C.

The wireless interface 134 communicates with an external apparatus such as the server 2 using WiFi communication or the like via a wireless network (not illustrated), and receives image data.

The storage 14 is an element or a storage medium that stores information required to realize various functions of the electronic paper 1, a control program, and the like. For example, a semiconductor device such as a RAM or a ROM or a storage medium such as a hard disk, a flash storage, or an SSD is used.

Note that a program and data may be held in different apparatuses, for example, the region for holding the data includes a hard disk drive and the region for holding the program includes a flash storage.

The image processor 15 is a part that converts the image data into an appropriate electric signal and performs processing such as enlargement or shrinking for appropriate outputting.

The image signal outputter 16 is part that outputs an image signal to be output to the display 111.

The power supply circuit 17 is a circuit that supplies power from the outside to the controller 10 and each part of the electronic paper 1 via the USB cable 3.

The battery 18 holds power for driving the electronic paper 1.

The battery 18 is charged with power via the USB cable 3 and supplies power to each part of the electronic paper 1.

The main body device is not limited to the electronic paper 1, and may be any device as long as the device incorporates a control apparatus capable of communicating via a connector connection port to which a connector of an external device is connectable.

### Problems With Known USB Connection

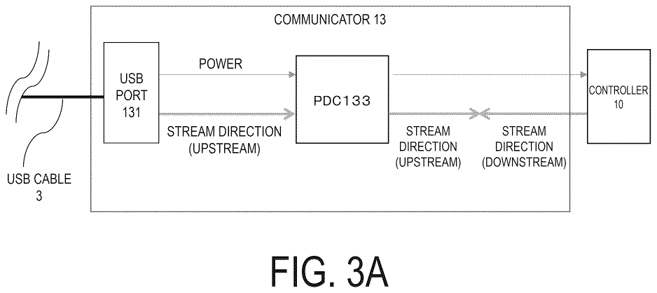

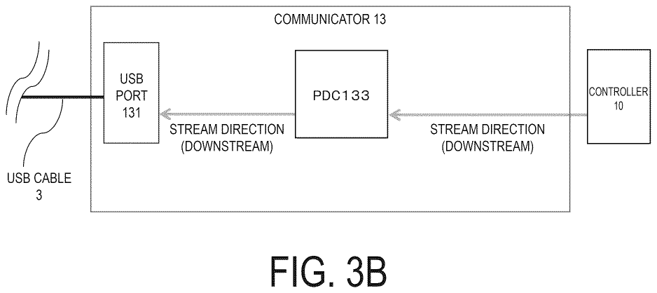

Next, problems with known USB connection will be described based on FIGS. 3A and 3B.

FIGS. 3A and 3B are explanatory diagrams illustrating problems with known USB connection.

FIGS. 3A and 3B illustrate only part of the configuration of the electronic paper 1 corresponding to the configuration related to the USB connection, that is, only part of the configuration of the controller 10 and the communicator 13.

In FIGS. 3A and 3B, it is assumed that the USB port 131 does not support the function of switching the data role (host/device), and supports only the host.

In this case, as illustrated in FIG. 3A, when the initial connection is performed under the sink mode under which power is supplied from the outside, since it is necessary to set the data role of the side to which power is supplied to the host at the time of the initial connection, the devices on both sides of the USB connection function as the host, and thus there is a concern that data collision (conflict) may occur.

On the other hand, as illustrated in FIG. 3B, when the initial connection is performed under the source mode under which power is supplied to the outside by changing the data direction so that the server 2 becomes the data receiving side, there is a problem in that the system cannot be activated due to a failure to supply power to the electronic paper 1 from the outside.

In order to solve such problems, the electronic paper system 100 of the disclosure performs the following USB connection processing.

USB Connection Processing of Electronic Paper System 100 of the Disclosure

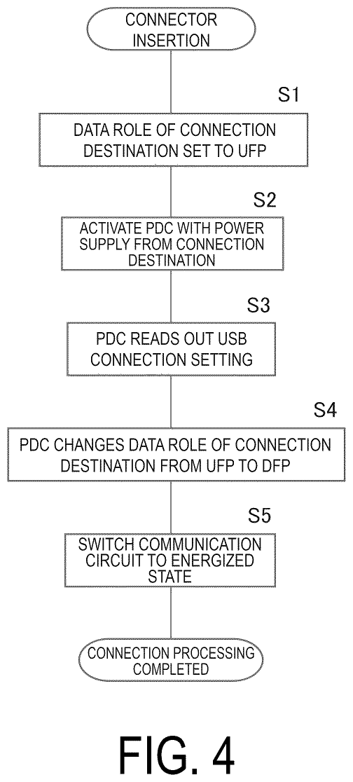

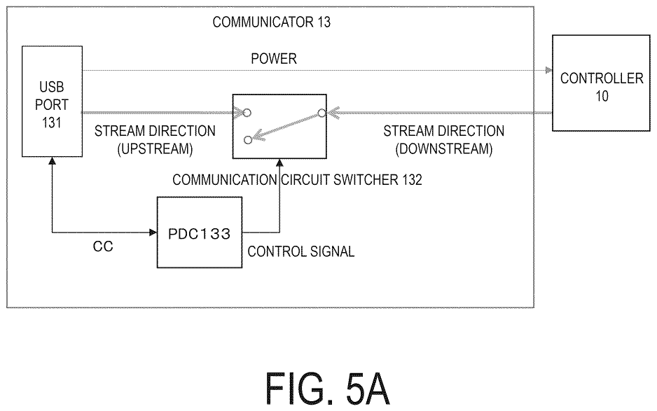

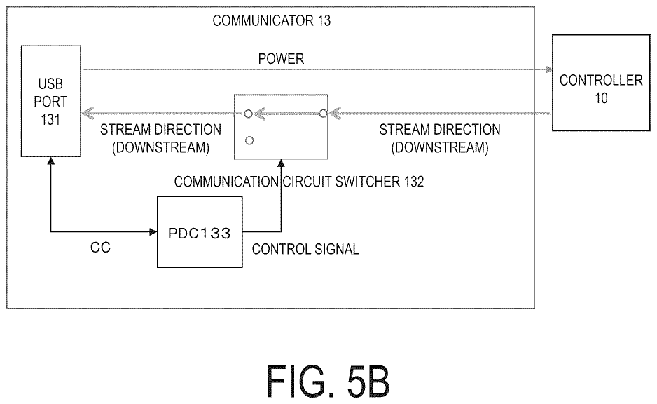

Next, the USB connection processing of the electronic paper system 100 of the disclosure will be described based on FIGS. 4, 5A, and 5B.

FIG. 4 is a flowchart illustrating an example of the USB connection processing of the electronic paper system 100 of FIG. 1.

In FIG. 4, it is assumed that the USB connector of the USB cable 3 is connected to the USB port 131.

It is assumed that the communication circuit switcher 132 sets the connection state of the data communication circuit to be in the disconnected state (OFF) before the USB connector is connected.

In this case, in step S1, when the USB connector is connected, a CC pin (not illustrated) inside the PDC 133 is connected to a pull-down termination resistor Rd (not illustrated), and the data role of the connection destination is set to an upstream facing port (UFP) (step S1).

When the data role of the connection destination is set to the UFP, a sink mode under which power is supplied from the connection destination to the electronic paper 1 functions.

FIGS. 5A and 5B are explanatory diagrams illustrating an outline of the USB connection processing of the electronic paper system 100 in FIG. 1.

FIG. 5A illustrates a state of the USB connector at the time of initial connection.

As illustrated in FIG. 5A, at the time of initial connection, the sink mode under which power is supplied from the connection destination to the electronic paper 1 functions.

On the other hand, since the communication circuit switcher 132 sets the connection state of the data communication circuit to be in the disconnected state (OFF), even if both sides of the USB connection function as hosts, data collision does not occur.

Next, in step S2, the PDC 133 is activated with power supply from the connection destination (power supply from a VBUS pin) (step S2).

Next, in step S3, the PDC 133 reads out a setting value related to the USB connection from the storage 14 (ROM) (step S3). The setting value includes a data role change (role swap) and switching setting of the communication circuit switcher 132.

Next, in step S4, the PDC 133 changes the data role of the connection destination from the UFP to a downstream facing port (DFP) by negotiating with the connection destination through the CC lines (step S4).

Next, in step S5, the communication circuit switcher 132 switches the connection state of the data communication circuit to the energized state (ON) (step S5), and completes the connection processing.

FIG. 5B illustrates a state of the USB connector in a connection completed state.

As illustrated in FIG. 5B, in the connection completed state, the communication circuit switcher 132 sets the connection state of the data communication circuit to the energized state (ON). Still, since the role of the connection destination is switched to the device due to the change in data role, data collision does not occur.

In this manner, the electronic paper 1 can control the server 2 while receiving the power supply from the server 2, and thus, it is possible to realize the electronic paper 1 including the communicator 13 that enables power supply from the external device to the main body device while avoiding collision of data signals when the connector of the external device is connected.

Preferred aspects of the disclosure include any combinations of the multiple aspects described above.

In addition to the embodiments described above, various modifications may be made regarding the disclosure. It should not be understood that those modifications do not belong to the scope of the disclosure. The disclosure shall include meanings equivalent to the scope of Claims and all modifications within the scope.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A communication control apparatus that functions while being incorporated into a main body device, the communication control apparatus comprising:
a connector connection port to which a connector of an external device is connectable;
a data communication circuit that performs data communication between the external device and the main body device;
a role control communication circuit that performs communication for controlling a role of the external device between the external device and the main body device;
an external device role switcher that switches the role of the external device between a host mode under which the external device operates as a host and a device mode under which the external device operates as a device;
a communication circuit switcher that switches a connection state of the data communication circuit between an energized state and a disconnected state; and
a controller that controls the external device role switcher and the communication circuit switcher, wherein
at a connection start timing when the connector of the external device is connected to the connector connection port, in a state where both a role of the main body device and the role of the external device are set to the host mode, the controller causes the communication circuit switcher to set at least part of the data communication circuit to be in the disconnected state, causes the main body device to perform an initial operation under a sink mode under which the main body device receives power supply from the external device, causes the external device role switcher to switch the role of the external device to the device mode, and then causes the communication circuit switcher to switch the data communication circuit in the disconnected state to the connection state.

2. The communication control apparatus according to claim 1, wherein the communication circuit switcher is a semiconductor switching element.

3. The communication control apparatus according to claim 1, wherein the controller causes the communication circuit switcher to maintain the data communication circuit in the disconnected state when the controller is unable to cause the external device role switcher to switch the role of the external device to the device mode.

4. The communication control apparatus according to claim 1, wherein
the role of the main body device constantly functions under the host mode, and
the main body device constantly functions under the sink mode.

5. The communication control apparatus according to claim 1, wherein the connector is a USB Type C interface.

6. The communication control apparatus according to claim 5, wherein the role control communication circuit is a CC1 line and a CC2 line of the USB Type C interface.

7. The communication control apparatus according to claim 5, wherein the data communication circuit is a TX1+ line, a TX1− line, an RX1+ line, an RX1− line, a D+ line, and a D− line of the USB Type C interface.

8. A communication control method for a communication control apparatus that functions while being incorporated into a main body device, the method comprising:
connecting a connector of an external device to a connector connection port of the main body device;
causing, at a connection start timing when the connector of the external device is connected to the connector connection port, in a state where both a role of the main body device and a role of the external device are set to a host mode under which the external device operates as a host, at least part of a data communication circuit that performs data communication between the external device and the main body device to be in a disconnected state, and the main body device to perform an initial operation under a sink mode under which the main body device receives power supply from the external device;
switching the role of the external device to a device mode under which the external device operates as a device; and
switching the data communication circuit in the disconnected state to a connection state.
